(19) United States
(12) Patent Application Publication
(10) Pub. No.: US 2003/0083696 A1
(43) Pub. Date: May 1, 2003

(54) Pacifier

(75) Inventor: Avraham Avital, Mevaseret Zion (IL)

Correspondence Address: SUGHRUE MION, PLLC, 2100 Pennsylvania Avenue, NW, Washington, DC, 20037-3213, US

(73) Assignee: HADASIT MEDICAL RESEARCH SERVICE & DEVELOPMENT COMPANY

(21) Appl. No.: 10/270,371

(22) Filed: Oct. 15, 2002

Related U.S. Application Data
(63) Continuation-in-part of application No. 09/486,931, filed on May 2, 2000, now abandoned.
Application No. 09/486,931 is a 371 of international application No. PCT/IL98/00428, filed on Sep. 3, 1998.

(30) Foreign Application Priority Data
Sep. 3, 1997 (IL) 121696

(51) Int. Cl. A61J 17/00

(52) U.S. Cl. 606/234

(57) ABSTRACT

A breathe-through, pacifier device facilitating breathing during nasal obstruction, comprising: a nipple consisting of a nipple head and a nipple neck provided with a front wall; a shield fixedly attached to, or integral with, the nipple neck; an air duct having a first opening at the end of the nipple head and a second opening in the front wall of the nipple neck, wherein an obturating means rotatably mounted on the nipple neck and having an eccentric opening is adapted to assume a first position in which the eccentric opening registers with the second opening in the front wall, and additional positions in which the eccentric opening is out of register with the second opening in the front wall, thereby obturating the air duct. A method for using the breathe-through pacifier and other embodiments of the breathe-through pacifier device are also disclosed.

### TECHNICAL FIELD

The present invention relates to a breathe-through pacifier.

### BACKGROUND ART

Newborns and young children use pacifiers mainly during sleep, starting from the first months of life until the age of 2-3 years. Newborns are obligatory nose-breathers until the age of 4-6 months, and any problem causing nasal congestion or obstruction, such as an upper respiratory tract infection, may induce sleep disturbances and even obstructive sleep apnea.

Nasal congestion or obstruction in children may have various causes, for instance, adenoid hypertrophy (enlarged lymph gland at the inner part of the nasal passages), choanal stenosis (constriction of nasal passages), or even the common cold. Whatever is the cause, nasal congestion plays a major role in the pathogenesis of pulmonary, cardiac and even neurological complications, and may be one of the major causes of Sudden Infant Death Syndrome (SIDS).

### DISCLOSURE OF THE INVENTION

It is thus one of the objects of the present invention to provide a device that will enable its user to bypass any obstruction in the nasal airways and maintain an open channel to the ambient air.

According to the invention, the above object is achieved by providing A method for using a breathe-through, pacifier device facilitating breathing during nasal obstruction, wherein the device includes a nipple consisting of a nipple head and a nipple neck, comprising the steps of: providing said nipple head with at least one first obstructable opening directly communicating with the free atmosphere; assuring that said opening is not obstructed, and placing the device in a user's mouth to enable its user to inhale, thereby to bypass any obstruction in the nasal airways and maintain an open channel to the ambient air.

The invention further provides a breathe-through, pacifier device facilitating breathing during nasal obstruction, comprising: a nipple consisting of a nipple head and a nipple neck, a shield fixedly attached to, or integral with, said nipple neck, said nipple head is provided with at least one first opening communicating with the free atmosphere; wherein said at least one first opening is selected from the group of openings consisting of at least one groove extending on a lateral portion of said nipple head, and an opening in the form of an enclosed tubular duct extending along a longitudinal axis of said nipple.

The invention also provides a breathe-through, pacifier device facilitating breathing during nasal obstruction, comprising: a nipple consisting of a nipple head and a nipple neck, a shield fixedly attached to, or integral with, said nipple neck, said nipple head is provided with at least one first opening directly communicating with the free atmosphere, to enable its user to bypass any obstruction in the nasal airways and maintain an open channel to the ambient air; wherein said at least one opening communicates with the free atmosphere via a second opening provided in said nipple neck, and a serrated rim surrounding said second opening in said nipple neck.

Still the invention provides a breathe-through pacifier device facilitating breathing during nasal obstruction, comprising a nipple consisting of a nipple head and a nipple neck; and a shield fixedly attached to, or integral with, said nipple neck, wherein said nipple head is provided with at least one first opening directly communicating with the free atmosphere to enable its user to bypass any obstruction in the nasal airways and maintain an open channel to the ambient air, and wherein said nipple further comprises a one-way valve sufficiently sensitive to respond to a minimal respiratory effort but preventing exhaled air from entering the nipple.

The invention further provides a breathe-through, pacifier device facilitating breathing during nasal obstruction, comprising: a nipple consisting of a nipple head and a nipple neck provided with a front wall; a shield fixedly attached to, or integral with, said nipple neck; an air duct having a first opening at the end of said nipple head and a second opening in the front wall of said nipple neck, wherein an obturating means rotatably mounted on said nipple neck and having an eccentric opening is adapted to assume a first position in which said eccentric opening registers with said second opening in said front wall, and additional positions in which said eccentric opening is out of register with said second opening in said front wall, thereby obturating said air duct.

### BRIEF DESCRIPTION OF THE DRAWINGS

The invention will now be described in connection with certain preferred embodiments with reference to the following illustrative figures so that it may be more fully understood.

With specific reference now to the figures in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a perspective view of a first embodiment of the pacifier according to the present invention;

FIG. 2 is a lateral view of the embodiment of FIG. 1;

FIG. 3 is a perspective view of another embodiment of the pacifier;

FIG. 4 is a lateral view of the embodiment of FIG. 3;

FIG. 5 is a cross-sectional view of the nipple head section of an embodiment provided with a longitudinal groove leading into the free atmosphere;

FIG. 6 is a view similar to FIG. 5, showing two lateral grooves;

FIG. 7 illustrates a fully enclosed tubular duct;

FIGS. 8a and 8b are lateral views, in partial cross-section, of a still further embodiment of the invention;

FIG. 9 is a semi-perspective view, in partial cross-section, of yet another embodiment of the invention;

FIG. 10 is a cross-sectional view of the end portion of the pacifier, in which a rotary thimble allows the air duct to communicate with the ambient air;

FIG. 11 represents the same view, but with the rotary thimble now obturating the air duct;

FIG. 12 is a frontal view of the pacifier of FIG. 9 in direction of arrow A, and

FIG. 13 is the same view as FIG. 12, but with the thimble in the obturating position.

### DETAILED DESCRIPTION

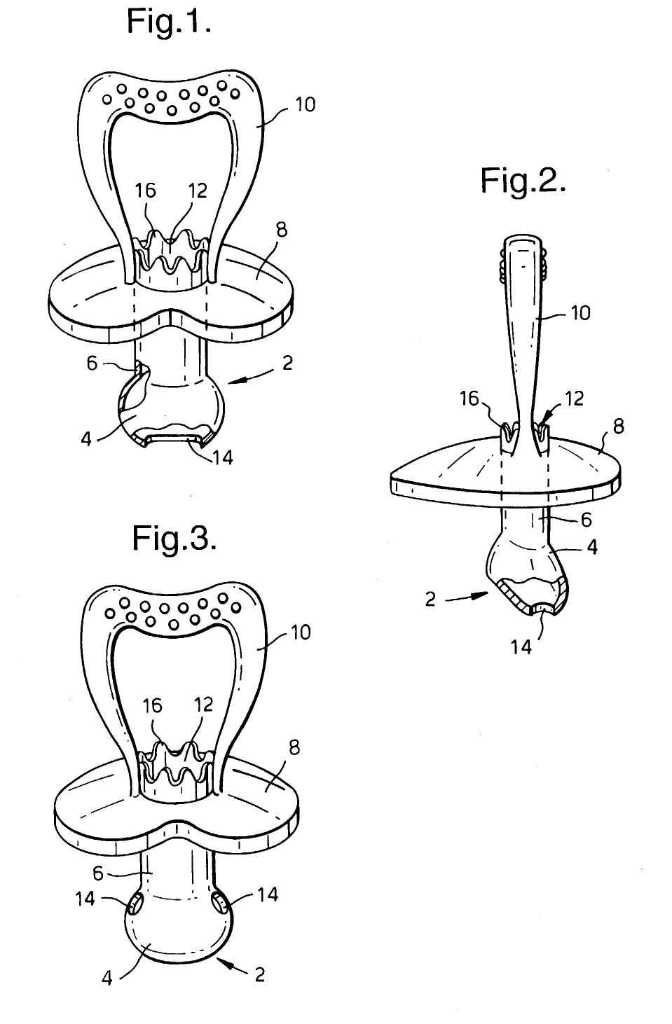

Referring now to the drawings, there is seen in FIGS. 1 and 2 a pacifier made of a tough but flexible plastic, comprising a nipple 2 consisting of a head section 4 and a neck section 6, a shield 8 fixedly attached to, or integral with, the neck portion 6 and a handle 10. Nipple 2 is hollow and the space defined by it opens into the free atmosphere beyond shield 8 via an opening 12 at the end of the neck section 6. Another opening 14 is seen at the end of the head section 4. Further seen is a serrated, crenellated or fenestrated rim 16 for preventing accidental obstruction of the channel constituted by nipple 2. The baby or infant sucking this pacifier is thus able to breathe through nipple 2, regardless of a possible blockage or congestion in the nasal tract.

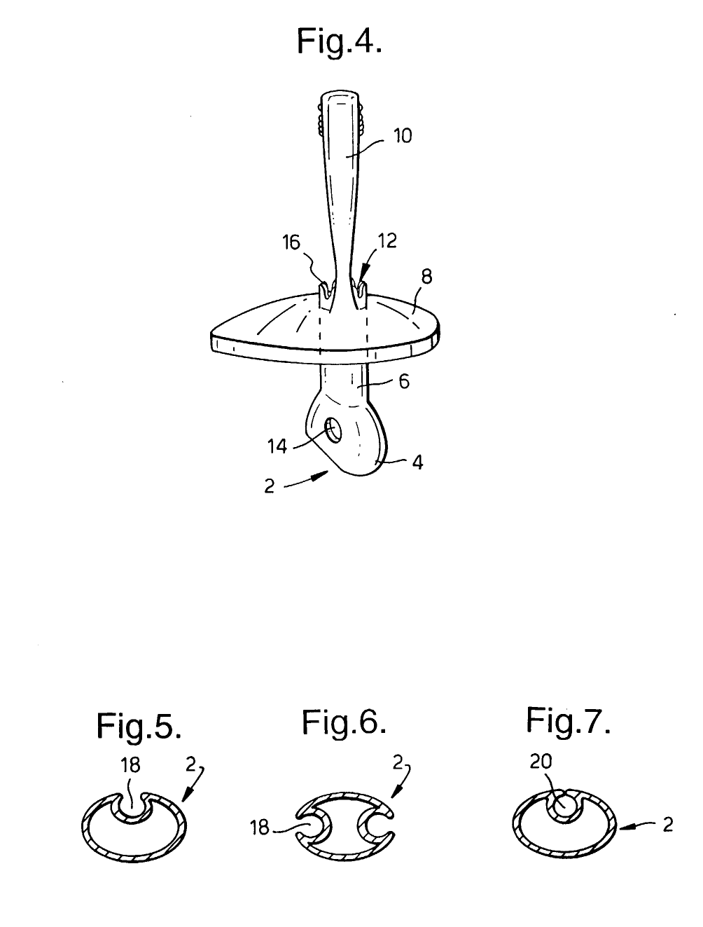

FIGS. 3 and 4 illustrate another embodiment of the pacifier according to the invention. As can be seen, the difference between the two embodiments resides in the fact that opening 14 is not located at the end of nipple head 4 (where it possibly might be occluded by the baby's tongue), but on each lateral portion of head 4, where openings 14 are well out of reach of the tongue.

Some infants might not like the pacifier according to FIGS. 1-4, because of their inability to suck the nipple head efficiently. For such cases, it is possible to provide pacifiers in which openings 14 are replaced by groove 18, as seen in the cross-sectional view of FIG. 5, produced in nipple 2 by “invagination” which, starting somewhere on head section 4, leads beyond shield 8 into the free atmosphere. It is also possible to have two lateral grooves 18 as shown in FIG. 6, or even a fully enclosed tubular duct 20 (FIG. 7).

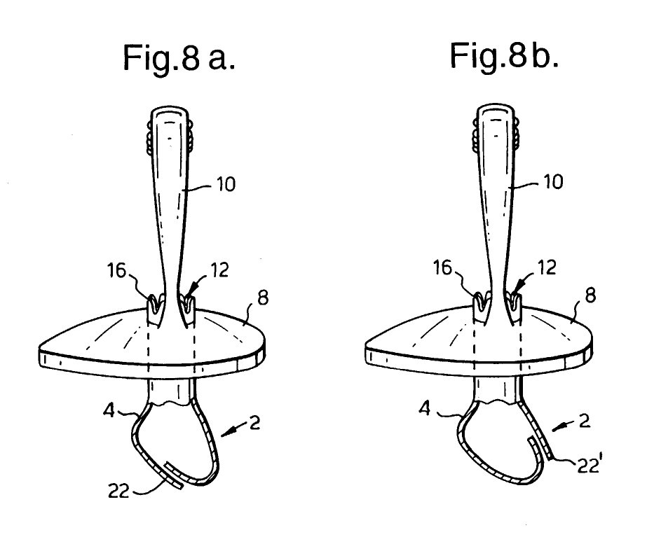

It is also possible to provide the nipple with a one-way valve 22, 22′ (FIGS. 8a and 8b) sensitive enough to respond to a minimal respiratory effort, i.e., a minimal negative pressure, but not permitting exhaled air to enter nipple 2, thereby preventing the deposition therein of mucous substances. In this case, exhaled air will simply escape between the baby's lips and shield 8.

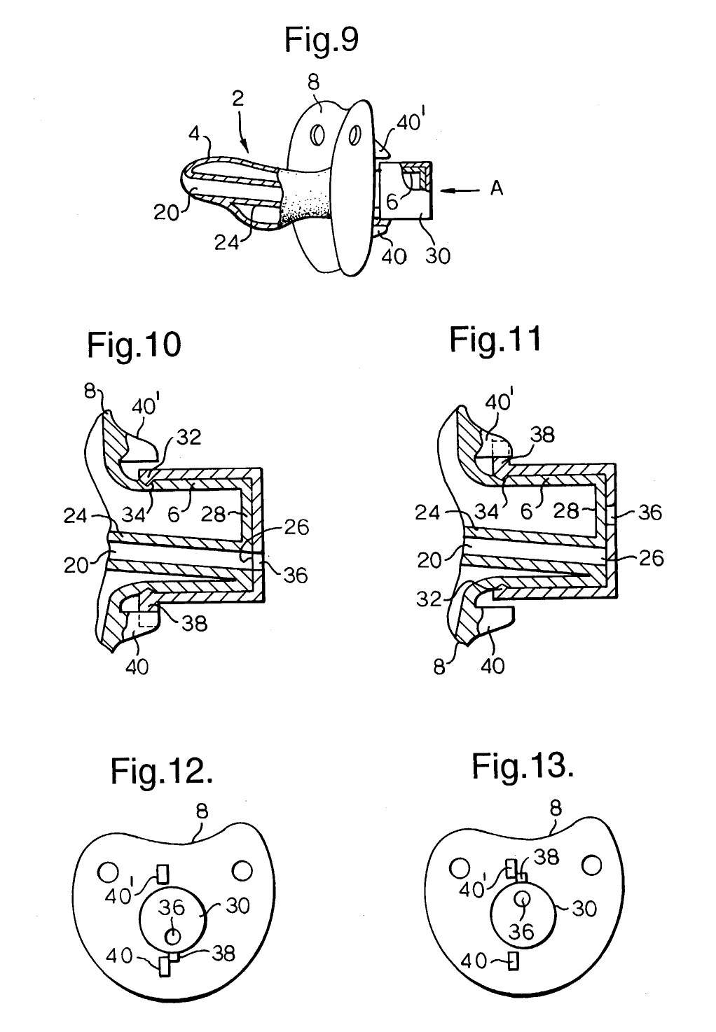

Yet another embodiment of the invention is illustrated in FIGS. 9, to 13, in which the flow of air through an air duct can be controlled at will by operating a rotary valve.

FIG. 9 shows a substantially hollow nipple 2 consisting of a head section 4 and a neck section 6 seen to better advantage in FIG. 10, with both of which sections is integral shield 8. An air duct 20, defined by a tubular member 24, leads to an opening 26 in the front wall 28 of neck section 6 through which opening air duct 20 is adapted to communicate with the ambient air.

Further seen in FIGS. 9 and 10 is a thimble rotatably mounted on neck section 6 and retained thereon by a snap-in joint consisting of a circumferential bead 32 and the end of thimble 30, and a corresponding circumferential groove 34 at the beginning of neck section 6. This joint gives thimble 30 one degree of freedom in rotation. Thimble 30 is provided with an eccentrically disposed opening 36 which, in FIG. 10, is seen to register with opening 26 in the front wall 28 of neck section 6. Clearly, with thimble 30 in the position shown in FIGS. 10 and 12, this embodiment acts as a breathe-through pacifier.

Also shown in FIG. 10 is a finger 38 integral with, and projecting from, thimble 30, as well as two nose-like projections 40, 40′ which are integral with shield 8. Projections 40, 40′ serve as abutments for finger 38, the first defining the “open” position of thimble 30 (FIG. 10), the other ensuring the “closed” position thereof.

The latter position is illustrated in FIG. 11, where thimble 30 is seen to have been turned, so that opening 36 in thimble 30 no longer registers with opening 26 in front wall 28 of neck section 6. With thimble 30 in this position, the pacifier acts as any conventional pacifier, enforcing nose breathing.

FIGS. 12 and 13 show the pacifier as seen in direction of arrow A in FIG. 9, representing this embodiment in the open and closed positions, respectively.

While nipple section 4 of the pacifier of FIG. 9 is substantially hollow, it could equally well consist of solid silicone, provided with air duct 20.

Although abutments 40, 40′ and finger 38 are convenient inasmuch as with their aid thimble 30 can also be handled in the dark or semi-dark, they could well be replaced by appropriately placed index markings. Also, while a thimble is a preferred solution to the problem of switching over from through-breathing to nose breathing and vice versa, other solutions are envisaged, such as a disk with a knurled rim, rotatably mounted on front wall 28 of neck section 6 and provided with an appropriately located eccentric opening 36.

While these pacifiers are obviously intended for babies and toddlers, if made of an appropriate size they could also be of use to adults suffering from obstructive sleep apnea associated with snoring, hypoxia and hypercarbia.

It will be evident to those skilled in the art that the invention is not limited to the details of the foregoing illustrated embodiments and that the present invention may be embodied in other specific forms without departing from the spirit or essential attributes thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

What is claimed is:

1. A method for using a breathe-through, pacifier device facilitating breathing during nasal obstruction, wherein the device includes a nipple consisting of a nipple head and a nipple neck, comprising the steps of:
providing said nipple head with at least one first obstructable opening directly communicating with the free atmosphere;
assuring that said opening is not obstructed, and
placing the device in a user's mouth to enable its user to inhale, thereby to bypass any obstruction in the nasal airways and maintain an open channel to the ambient air.

2. A breathe-through, pacifier device facilitating breathing during nasal obstruction, comprising:
a nipple consisting of a nipple head and a nipple neck,
a shield fixedly attached to, or integral with, said nipple neck,
said nipple head is provided with at least one first opening communicating with the free atmosphere;
wherein said at least one first opening is selected from the group of openings consisting of at least one groove extending on a lateral portion of said nipple head, and an opening in the form of an enclosed tubular duct extending along a longitudinal axis of said nipple.

3. The device as claimed in claim 2, wherein said at least one first opening communicates with the free atmosphere via a second opening provided in said nipple neck.

4. A breathe-through, pacifier device facilitating breathing during nasal obstruction, comprising:
a nipple consisting of a nipple head and a nipple neck,
a shield fixedly attached to, or integral with, said nipple neck,
said nipple head is provided with at least one first opening directly communicating with the free atmosphere, to enable its user to bypass any obstruction in the nasal airways and maintain an open channel to the ambient air;
wherein said at least one opening communicates with the free atmosphere via a second opening provided in said nipple neck, and
a serrated rim surrounding said second opening in said nipple neck.

5. A breathe-through pacifier device facilitating breathing during nasal obstruction, comprising
a nipple consisting of a nipple head and a nipple neck; and
a shield fixedly attached to, or integral with, said nipple neck,
wherein said nipple head is provided with at least one first opening directly communicating with the free atmosphere to enable its user to bypass any obstruction in the nasal airways and maintain an open channel to the ambient air, and
wherein said nipple further comprises a one-way valve sufficiently sensitive to respond to a minimal respiratory effort but preventing exhaled air from entering the nipple.

6. A breathe-through, pacifier device facilitating breathing during nasal obstruction, comprising:
a nipple consisting of a nipple head and a nipple neck provided with a front wall;
a shield fixedly attached to, or integral with, said nipple neck;
an air duct having a first opening at the end of said nipple head and a second opening in the front wall of said nipple neck,
wherein an obturating means rotatably mounted on said nipple neck and having an eccentric opening is adapted to assume a first position in which said eccentric opening registers with said second opening in said front wall, and additional positions in which said eccentric opening is out of register with said second opening in said front wall, thereby obturating said air duct.

7. The device as claimed in claim 6, wherein said obturating means is a thimble mounted on said neck section and having one degree of freedom in rotation relative to said neck section.

8. The device as claimed in claim 6, further comprising at least one abutment means fixedly attached to, or integral with, said shield, which abutment means, together with a finger integral with said obturating means, determines the position of said means in which said air duct is communicating with the ambient air.
